(19) United States
(12) Patent Application Publication
(10) Pub. No.: US 2009/0281662 A1
(43) Pub. Date: Nov. 12, 2009

(54) Simulator for visual inspection apparatus

(75) Inventor: Tsuyoshi Ueyama, Toyota-shi (JP)

Correspondence Address: OLIFF & BERRIDGE, PLC, P.O. BOX 320850, ALEXANDRIA, VA, 22320-4850, US

(73) Assignee: DENSO WAVE INCORPORATED, Tokyo (JP)

(21) Appl. No.: 12/453,341

(22) Filed: May 7, 2009

(30) Foreign Application Priority Data
May 8, 2008 (JP) 2008-122185

(51) Int. Cl. B25J 19/04

(52) U.S. Cl. 700/259; 901/47

(57) ABSTRACT

A simulator for a visual inspection apparatus is provided. The apparatus is equipped with a robot having an arm and a camera attached to a tip end of the arm, the camera inspecting a point being inspected of a workpiece. Using 3D profile data of a workpiece, information of lenses of cameras, operational data of a robot, simulation for imaging is made for a plurality of points being inspected of the workpiece. For allowing the camera to image the points being inspected of the workpiece, a position and an attitude of the tip end of the arm of the robot are obtained. Based on the obtained position and attitude, it is determined whether or not the imaging is possible. When the imaging is possible, installation-allowed positions of the robot are decided and outputted as candidates of positions for actually installing the robot.

### CROSS REFERENCES TO RELATED APPLICATION

The present application relates to and incorporates by reference Japanese Patent Application No. 2008-122185 filed on May 8, 2008.

### BACKGROUND OF THE INVENTION

1. Technical Field

The present invention relates to a simulator, and in particular, to a simulator for a visual inspection apparatus that uses a camera photographing a point to be inspected of a workpiece using a robot.

2. Related Art

A simulator for visual inspection apparatus is known by Japanese Patent Laid-open Publication Nos. 2005-52926 and 2004-265041. Of these references, the publication No. 2005-52926 discloses a simulator for setting operational positions of a robot. Practically, CAD (computer aided design) data of a workpiece are used to show 3D views of the workpiece at various different view points. This allows the operator to select a view point which is most proper for imaging a position being inspected of the workpiece. The selected view point is designated as the position of a camera, and based on this camera position, an operational position of the robot is set.

The simulator disclosed by the foregoing publication No. 2004-265041 is to easily correct operational positions and attitudes of a robot. This system considers a situation where the camera position is decided and the operational position of the robot is set separately from a site in which a visual inspection apparatus is actually installed. In such a situation, it is very frequent that the operational position of the robot is obliged to be corrected at the site.

In a system using the simulators disclosed by the foregoing publications No. 2005-52926 and 2004-265041, the position at which the robot is installed is previously decided due to the geographical relationship and only one camera with a single-vision lens is attached to the robot.

By the way, prior to actual introduction of the visual inspection apparatus into the production line, it is often undecided that the lens of the camera should have what kind of focus. Hence, when the simulators disclosed by the publications No. 2005-52926 and 2004-265041 are used which simulate on the assumption that the robot has only one camera, the camera used for teaching is often different from the camera attached to the actual robot of the visual inspection apparatus in the production line. As a result, at the operational position of the robot which has been taught, the lens of the camera fails in focusing a desired inspecting point of the workpiece, causing the inspecting point to blur in inspected images.

When the above problem arises, that is, visually blurring focus between the preparatory simulation and the actual visual inspection arises due to the different camera lenses, the operation position and attitude of the robot can be corrected to correct the focus by using the simulator disclosed by the reference No. 2004-265041. However, this simulator is still confronted with a difficulty. When this simulator is used, the installation positions of both a workpiece and the robot have to be decided previously. Thus, when the robot is actually installed in a factory, it is sometimes difficult to install the robot at a position which has been decided in the simulation. In this case, the installation position of the robot should be changed to perform the simulation again. Hence, this re-simulation will decrease efficiency in installing the robot.

### SUMMARY OF THE INVENTION

The present invention has been made in consideration of the foregoing problem, and an object of the present invention is to provide a simulator which is able to simulate an actual visual inspection in a manner that the actual visual inspection apparatus is able to avoid its camera focus from blurring at a point being inspected of a workpiece.

In order to realize the above object, as one mode, the present invention provides a simulator dedicated to a visual inspection apparatus equipped with a robot having an arm and a camera attached to a tip end of the arm, the camera inspecting a point being inspected of a workpiece, comprising: display means that makes a display device three-dimensionally display the workpiece; direction setting means that sets a direction of imaging the point being inspected of the workpiece by displaying the workpiece on the display device from different view points, the direction of imaging being a light axis of the camera; imaging point setting means that sets an imaging point to image the point being inspected of the workpiece using a lens of the camera, which lens is selected as being proper for imaging the point being inspected; position/attitude obtaining means that obtains a position and an attitude of the tip end of the arm of the robot based on the direction of the imaging and the imaging point; representation means that represents the robot in a displayed image so that the robot is installed at an installation-allowed position which is set in the displayed image; determination means that determines whether or not it is possible to move the tip end of the arm to the obtained position so that the camera is located at the imaging point and it is possible to provide the tip end of the arm with the obtained attitude so that, at a moved position of the tip end of the arm, the camera is allowed to image the point being inspected, when the robot is installed at the installation-allowed position which is set in the displayed image; and output means that outputs the installation-allowed position for the robot as candidates of positions for actually installing the robot when it is determined by the determination means that it is possible to move the tip end of the arm and it is possible to provide the tip end of the arm with the obtained attitude.

As a second mode, the present invention provides a simulator dedicated to a visual inspection apparatus equipped with a robot having an arm and a camera fixed located, the camera inspecting a point being inspected of a workpiece attached to a tip end of the arm. In this case, the simulator comprises display means that makes a display device three-dimensionally display the workpiece; direction setting means that sets a direction of imaging the point being inspected of the workpiece by displaying the workpiece on the display device from different view points, the direction of imaging being a light axis of the camera; direction matching means that matches the point being inspected of the workpiece with the light axis of the camera fixedly located; imaging point setting means that sets an imaging point to image the point being inspected of the workpiece using a lens of the camera, which lens is selected as being proper for imaging the point being inspected; position/attitude obtaining means that obtains a position and an attitude of the tip end of the arm of the robot based on the direction of the imaging and the imaging point; representation means that represents the robot in a displayed image so that the robot is installed at an installation-allowed position which is set in the displayed image; determination means that determines whether or not it is possible to move the tip end of the arm to the obtained position and it is possible to provide the tip end of the arm with the obtained attitude so that, at a moved position of the tip end of the arm, the camera is allowed to image the point being inspected, when the robot is installed at the installation-allowed position which is set in the displayed image; and output means that outputs the installation-allowed position of the robot as candidates of positions for actually installing the robot when it is determined by the determination means that it is possible to move the tip end of the arm and it is possible to provide the tip end of the arm with the obtained attitude.

### BRIEF DESCRIPTION OF THE DRAWINGS

In the accompanying drawings:

FIG. 1 is a perspective view showing a simulator according to embodiments of the present invention;

FIG. 2 is a block diagram showing the electrical configuration of the simulator in the first embodiment;

FIG. 3 is a perspective view showing a robot with which a visual inspection apparatus is produced;

FIG. 4 is a partial perspective view showing the tip end of an arm of the robot together with a coordinate system given to the flange;

FIG. 5 is a perspective view exemplifying a workpiece employed in the first embodiment;

FIG. 6 is a perspective view illustrating an inspecting point and an imaging range both given to the workpiece in FIG. 5;

FIG. 7 is a perspective view illustrating a sight line viewing toward the inspecting point in FIG. 6;

FIG. 8A is a sectional view showing the positional relationship between the inspecting point and an imaging point;

FIG. 8B is a perspective view showing the positional relationship between the inspecting point and the position of the tip end of the arm;

FIG. 9 is an illustration exemplifying the screen of a display device in which an installation-allowed region for the robot is represented;

FIGS. 10A and 10B are flowcharts outlining a simulation employed in the first embodiment;

FIG. 11 is a partial flowchart outlining a simulation employed in a second embodiment of the simulator according to the present invention;

FIG. 12 is an illustration exemplifying the screen of the display device in which a installation-allowed region for the robot is represented, which is according to the second embodiment; and

FIG. 13 is a perspective view illustrating a camera fixedly located and a workpiece held by the robot.

### DETAILED DESCRIPTION OF PREFERRED EMBODIMENTS

Referring to the accompanying drawings, various embodiments of the simulator according to the present invention will now be described.

### First Embodiment

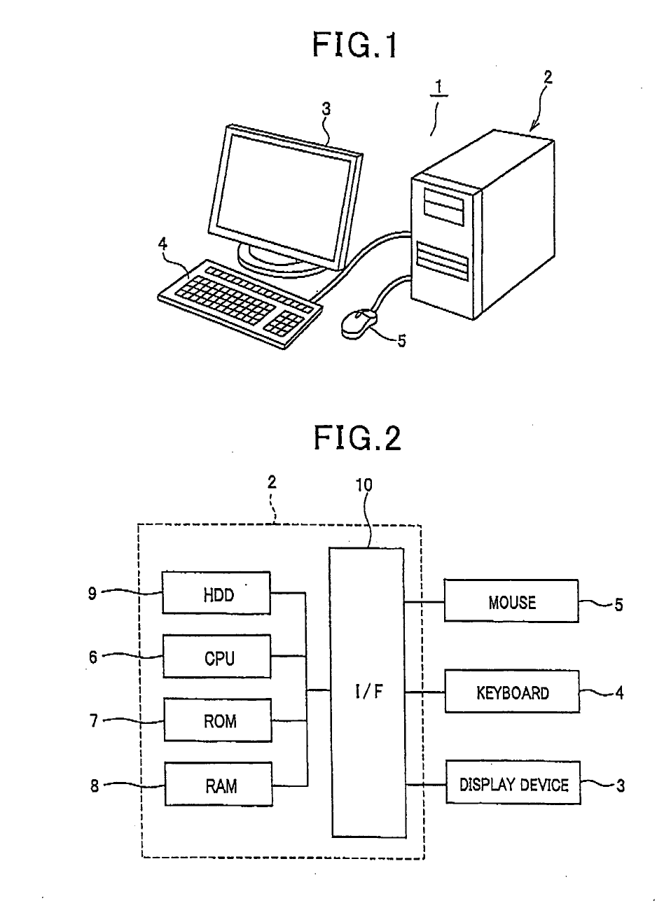

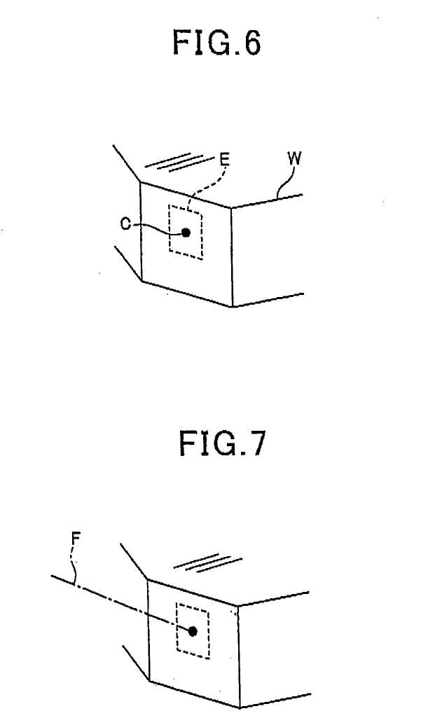

Referring to FIGS. 1-10, a first embodiment of the present invention will be described.

The present embodiment adopts a visual inspection apparatus as a target to be simulated. This visual inspection apparatus is used in for example in assembling plants, in which the visual inspection apparatus includes a robot with an arm, which robot is disposed on the floor or a ceiling part of an inspection station and a camera attached to the end of the arm. In the inspection station, there is also disposed a carrier device which carries a workpiece being inspected until a position where the inspection is carried. The workpiece, which is at the inspecting point, is subjected to visual appearance inspection.

The robot is controlled by a controller in a three-dimensional (3D) eigenvalue coordinate system given to the robot, so that the camera can be moved freely in its spatial position and its attitude (direction). While moving the camera to one or more positions which are previously set, the camera acquires images of portions of the workpiece which are necessary to be inspected and the acquired images are processed by an image processor. This image processing makes it possible to perform the appearance inspection at each portion of the workpiece as to whether or not components are properly assembled with each other at each portion.

In the visual inspection apparatus according to the present embodiment, a workpiece is given plural portions being inspected about their appearances. Some workpieces may include several dozen portions to be inspected. This kind of workpiece is a target for simulation in the present embodiment. The simulation simulates optimum imaging conditions of the camera, which include optimum focal lengths, optimum positions, and optimum imaging directions, which are matched to each of the portions being inspected of the workpiece. The results of this simulation are presented to a user, so that the user can see the results to propose practical facilities and layouts for the visual inspection in the site.

In the present embodiment, for this simulation, the profiles of workpieces are prepared beforehand as 3D CAD (computer aided design) data (serving as three-dimensional profile data). Additionally, portions being appearance-inspected of each workpiece, a position at which each workpiece should be stopped fro the appearance inspection (referred to as an inspecting point), the direction of each workpiece at the inspecting point, a robot being used, and a position and region where the robot can be installed are decided before the simulation.

An apparatus for the simulation, that is, a simulator, is provided as a personal computer (PC) 1 shown in FIG. 1. This computer 1 has a main unit 2, to which a display device 3 (display means), which serves as an output device or output means, and a keyboard 4 and a mouse 5, which are input devises or input means, are connected. The display device 3 is for example a liquid crystal display that is able to perform 3D graphic display. The computer main unit 2 has components shown in FIG. 2, which include a CPU (central processing unit) 6, a ROM (read-only memory) 7, a RAM (random access memory) 8, a hard disk (HDD) as a high-capacity storage, and an interface (I/F) 10. To the interface 10, the display device 3, the keyboard 4, and the mouse 5 are communicably connected.

The hard disk 9 stores various program data, which include a program for the simulation (simulation program), a program for three-dimensionally displaying the workpiece on the display device 3 based on the 3D CAD data of the workpiece (workpiece display program), a program for three-dimensionally displaying the robot used for the visual inspection (robot display program), and a program for conversion coordinate systems between a 3D coordinate system with which the workpiece is three-dimensionally displayed and a 3D coordinate system with which the robot is three-dimensionally displayed (coordinate-system conversion program).

The hard disk 9 accepts, via the interface 10, various kinds of data for storage thereof. The data include the 3D CAD data (3D contour data) of each workpiece for the visual inspection which uses the camera (3D profile data), the 3D profile data of the robots used for the visual inspection, the data of programs for the robot operation, and the data of lenses for plural cameras used for the visual inspection. The lens data include the data of lens focal lengths and angles of views. The hard disk 9, which stores the various data in this way, functionally works as profile data storing means for workpieces and robots, lens data storing means, and robot's operation data storing means.

The CPU 6 executes the workpiece display program, which is stored in advance in the hard disk 9, such that the CAD data are used to three-dimensionally display the workpiece on the display device 3. Hence it can be defined that the CPU 6 functions as means for controlling display of the workpiece. In this control, the CPU 6 responds to operator's manual operations at the mouse 5 to change view points (observing points; the directions of the view points and the sizes of view fields) for the workpiece 3D display. Thus the mouse 5 can function as part of view-point position change operating means. Of course, the view point can be changed in response to operator's manual operations at the keyboard 4.

The operator is thus able to change the view points to three-dimensionally display the workpiece on the display device 3 from any view angle. Through this change operation of the view points and observation of the displayed images at the respective view points, the operator is able to determine that the currently displayed image on the display device 3 gives a proper inspecting condition for visually inspected portion(s) of a workpiece. Hence, the operator specifies an inspecting point on the display screen using the mouse 5 for example, the CPU 6 responds to this operator's operation by deciding the point specified on the workpiece through the displayed image and storing the decided inspecting point into the RAM 8. When the operator operates the mouse 5 to specify, on the display screen, a desired region including the specified inspecting point, the CPU 6 also defines such a region and stores data of the defined region into the RAM 8 as information showing a imaging range of the camera for the visual inspection. Thus the mouse 5 also works as part of input means for the inspecting point and the inspiration range.

The images displayed by the display device 3 are treated as inspection images acquired by the camera in the appearance inspection. When an image is displayed which is considered proper by the operator as an image showing a portion of a workpiece being inspected, the operator specifies that image as a desired image by using the input device, i.e., the keyboard 4 or the mouse 5. In response to this specification, the CPU 6 calculates, as the direction of a sight line, a linear line connecting the position of the view point to the workpiece in the 3D coordinate system (that is, view point information given by the specified image) and the inspecting point. This sight line (linear line) provides a light axis of the camera in the appearance inspection. The CPU 6 thus functions as camera attitude setting means.

It is also possible that the operator uses the keyboard 4 to input into the hard disk 9 a possible range in which the robot is installed. Accordingly, the keyboard 4 functions as part of input means for inputting positional information showing ranges into which the robot can be installed. The robot's installation-possible range is inputted as positional information given in the 3D coordinate system previously given to images displayed by the display device 3. Incidentally this robot's installation-possible range may be inputted as position information given in the 3D coordinate system for the workpiece.

The CPU 6 performs the robot display program, which is stored in the hard disk 9, whereby the robot is three-dimensionally displayed by the display device 3 based on the 3D profile data of the robot. Thus the CPU 6 functions as robot display control means. In addition, the CPU 6 performs the robot operation program by using the specification data of the robot, including an arm length and an arm movable range, whereby it is possible to move the robot displayed by the display device 3.

When an actually robot installation position is decided in the range where the robot is allowed to be installed, the CPU 6 performs the coordinate-system conversion program stored into the hard disk 9. Accordingly, a coordinate conversion is made between the 3D coordinate of the robot (i.e., the robot coordinate) and the 3D coordinate of the workpiece (i.e., the workpiece coordinate). When the origin of the workpiece coordinate system and the gradients of the X, Y and Z axes and the origin of the robot coordinate system and the gradients of the X, Y and Z axes, which are all in the 3D coordinate system of the displayed image, are given, the coordinate conversion can be performed. The CPU 6 also functions as workpiece-robot coordinate converting means.

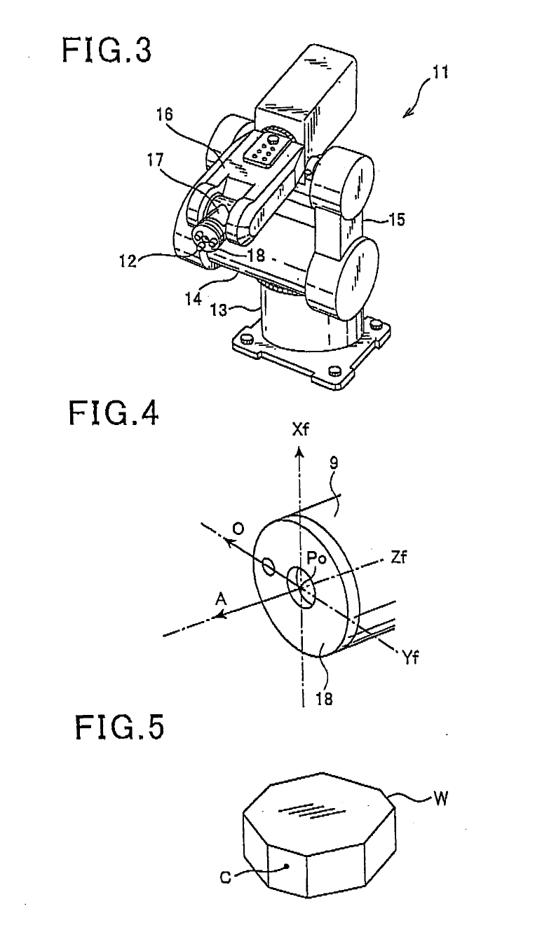

With reference to FIGS. 3-10A and 10B, the operations of the simulation, which is performed using the simulator (i.e., the computer 1), will now be detailed.

In the embodiment, the robot is a 6-axis vertical multi-joint robot 11, which is as shown in FIG. 3, for instance. The robot 11 is equipped with an arm at a tip end of which a camera 12 is equipped. Practically, the robot 11 comprises a base 13 and a shoulder 14 swivelably supported by the base 13 in the horizontal direction. The robot 11 also comprises a lower arm 15 swivelably supported by the shoulder 14 in the vertical direction and an upper arm 16 swivelably supported by the lower arm 16 in the vertical direction and rotatably (twistable) supported by the upper arm 16. Moreover, the robot 11 comprises a wrist 17 swivelably supported by the upper arm 16 in the vertical direction and a flange 18 rotatably (twistable) arranged at the tip of the wrist 17. The camera 12 is installed at the flange 18, which is located at the tip end of the upper arm 16.

A 3D coordinate system is given to each of the joints of the robot 11. The coordinate system given to the base 13 which is spatially fixed is treated as the robot coordinate, so that the coordinate of the base 13 provides a robot coordinate. The coordinate systems given to the other joints change depending on the rotations of the other joints, because of changes in their spatial positions and attitudes (directions) in the robot coordinate system.

A controller (not shown) controls the operations of the robot 11. The controller receives detected information showing the positions of the respective joints including the shoulder 14, the arms 15 and 16, the wrist 17, and the flange 18 and information showing the length of each of the joints, which is previously stored in the hard disk 9. The positional information is given by position detecting means such as rotary encoders disposed at each joint. Based on the received information, the controller uses its coordinate conversion function to obtain the position and attitude of each joint in each of the joint coordinate systems. This calculation is carried out by converting the position and attitude of each joint in their coordinate systems into the positions and attitudes in the robot coordinate system.

Of the coordinate systems given to the respective joints, the coordinate system given to the flange 18 can be shown as in FIG. 4. The center PO of the tip end surface of the flange 18 is taken as the origin, two mutually-orthogonal coordinate axes Xf and Yf are set in the tip end surface, and one coordinate axis Zf is set by the rotation axis of the flange 18. Of the position and attitude of the flange 18 (that is, the tip end of the arm), the position is shown by a position in the robot coordinate system, which position is occupied by the center of the tip end surface of the flange 18, i.e., the origin PO in the coordinate system given to the flange 18.

To define the attitude of the flange 18, an approach vector A and an orient vector O are defined as shown in FIG. 4, where the approach vector A has a unit length of “1” so as to extend from the origin PO in the negative direction along the Zf axis and the orient vector O has a unit length of “1” so to extend from the origin PO toward the positive direction along the Zf axis. When the coordinate system of the flange 18 is translated so that the origin PO completely overlaps with the origin of the robot coordinate system, the attitude of the flange 18 is indicated by the directions of both the approach vector A and the orientation vector O.

The controller of the robot 11 responds to reception of lo information showing both the position and the attitude of the flange 18 by controlling the respective joints so that the flange 18 reaches a specified position and adjusts its attitude to a specified attitude at the specified position. For realizing this control, the robot operation program stored in the hard disk 9 reads out and performed by the controller of the robot 11.

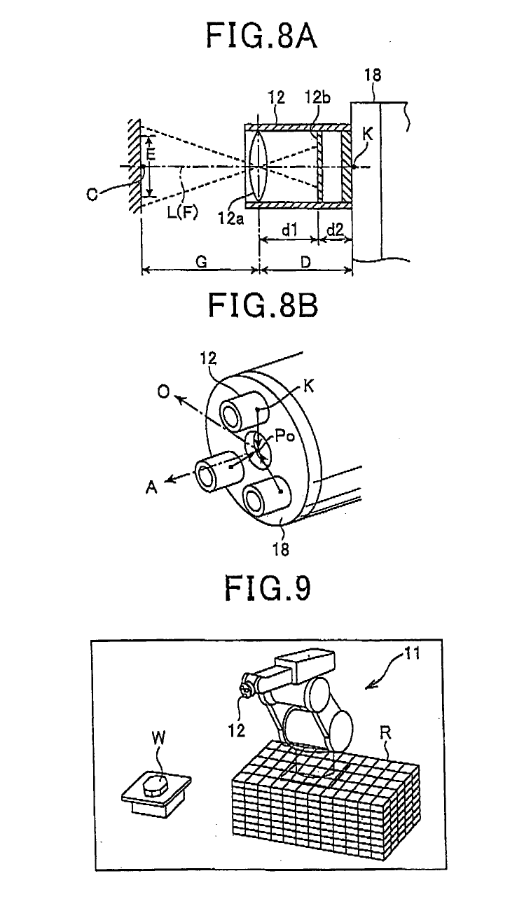

As shown in FIG. 8B, the camera 12 is composed of a plurality of cameras arranged at the flange 18. Each camera 12 has a light axis L as shown in FIG. 8A, which is along a liner line passing the center of a lens 12a disposed in the camera. The light axis is in parallel with the approach vector A. Each of the lenses 12a of the respective cameras 12 has a fixed focal point and its focal distance is different from the other lenses 12a. As illustrated in FIG. 8A, in each camera 12, there is a CCD 12b which serves as an imaging element, which is located at a position displaced by the focal distance d1 from the center of the lens 12a. The CCD 12b is also located apart from the tip end surface of the flange 18 by a predetermined distance d2. Thus the distance D between the lens 12a and the tip end surface of flange 18 is equal to a distance “d1+d2”, which changes every camera 12.

The light axis L of each camera 12 intersects with a point K on the tip end surface of the flange 18. Data showing a vector extending from the point K to the center PO of the flange 18, which vector is composed of a distance and a direction, is previously stored in the hard disk 9 as camera-installing positional data, together with data showing the foregoing distance D.

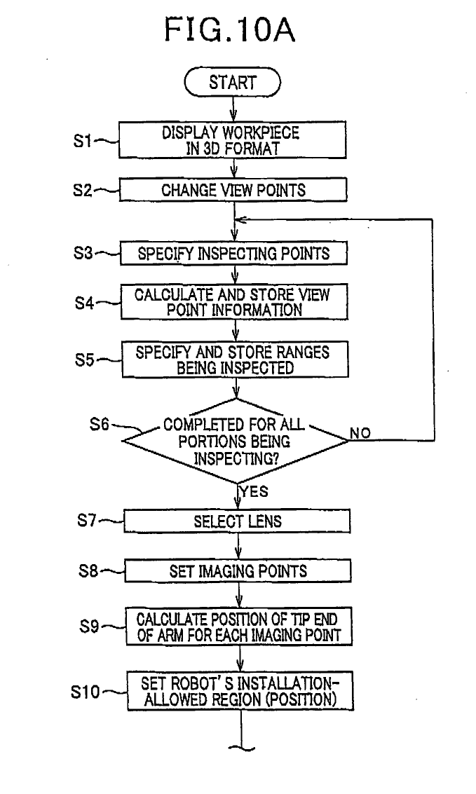

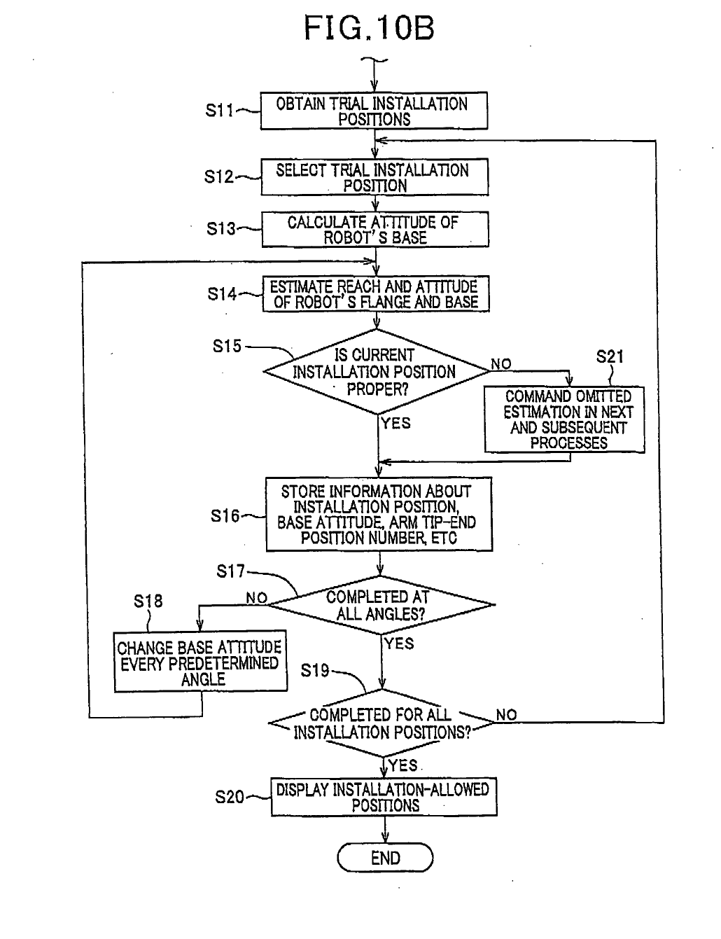

The flowchart shown in FIGS. 10A and 10B will now be described, which is executed by the CPU 6.

First of all, in response to an operator's command, the CPU 6 instructs the display device 3 to display the 3D profile of a workpiece W (step S1). The CPU 6 then responds to operator's operation commands at the mouse 5 to change the position of a view point so that a portion being visually inspected of the workpiece W is displayed and the displayed portion is proper for visual inspecting (step S2). When such a proper displayed image is obtained, the operator operates the mouse 5 to specify, as an inspection portion C, for example, the center of the portion being visually inspected, as shown in FIG. 5 (step S3).

The CPU 6 calculates, as a sight line F (refer to FIG. 7), a liner line connecting the position of the view point in the image displayed in the 3D coordinate system given to the workpiece W and the inspecting point C, and stores the calculated sight line F into the RAM 8 as view point information (step S4). Thus this calculation at step S4 functionally realizes view-point information calculating means and view-point information storing means. The operator proceeds to specification of a desired range with the use of the mouse 5. The CPU 6 receives this specification to specify the desired range including the inspecting point C, as a range being inspected (or simply, inspection range) (step S5). The CPU 6 stores, into the RAM 8, information showing the range being inspected, which is specified in the 3D coordinate system given to the workpiece W, thus realizing the inspection range storing means (step S5).

The CPU 6 determines whether or not the specification of both the inspecting point C and the inspection range has been completed for all the portions being visually inspected of the workpiece W (step S6). If the determination at this step S6 is YES, i.e., the specification for all the portions has been completed, the CPU 6 proceeds to the next step S7. In contrast, the determination NO at step S6 makes the processing return to step S3.

At the step S7, for each of the inspecting points C, the lens information is referred to select a lens having an angle of view that covers the entire inspection range for each inspection position, and select a camera 12 having such a lens (step S7). The CPU 6 sets an imaging point K depending on the focus distance of the lens 12a of the selected camera 12 (step S8). The imaging point K is defined as the position of the foregoing intersection K in the coordinate system given to the workpiece. The coordinate of this imaging point K can be detailed as follows.

That is, for imaging the focused inspecting point C onto the CCD 12b as shown in FIG. 8A, the distance G from the inspecting point C to the lens 12a is decided uniquely based on the focal length. The distance from the lens 12a to the distal end surface of the flange 18 is D, so that the imaging point K has a coordinate located a distance of “G+D” apart from the inspecting point C along the sight line (light axis L).

After the imaging point K is produced for each of the inspecting points C, the CPU 6 calculates the position of the tip end of the arm for each imaging point K in the imaging, that is, the position and the attitude of the center PO of the flange 18 in the workpiece coordinate system (step S9). The calculation of the coordinate at the arm tip-end position in the imaging can be carried out using the coordinate of the imaging point K and the distance and direction (vector quantity) from the imaging point K to the center PO of the flange 18. The positional relationship between the imaging points K of the respective camera 12 and the center PO of the flange 18 is previously stored in the hard disk 9.

On the assumption that the approach vector A is in parallel with the liner line F connecting the view point in the displayed image and the inspecting point C, the direction of the orient vector O is calculated based on the positional relationship between the imaging points K and the center PO of the flange 18, whereby the attitude of the flange 18 can be obtained.

In this way, the coordinate of the flange 18 is obtained for each inspecting point C, positions at which the robot 11 can be installed are decided as installing-position candidates. For this decision, as a preparatory step, the operator assumes that the horizontal plane (i.e., the plane along the X- and Y-axes) of the image coordinate is the floor of the inspection station and on this assumption, the workpiece coordinate is fixed to the image coordinate to give the workpiece a position and an attitude (direction) being taken in the inspection station.

After this, when the operator operates the keyboard 4 to set, in the image coordinate, a position or a region in which the robot 11 can be installed (step S10 in FIG. 10A). In this embodiment, the region R is set as an installation-allowed region (position). In response to this setting, the CPU 6 calculates the central coordinate of the installation-allowed region R, and, within this region R, obtains trial installation positions displaced a given distance from the central position in the upward, downward, rightward and leftward directions (step S11). This trial installation positions are obtained at K-places.

The CPU 6 selects one of the trial installation positions (step S12). Thus, in the first routine, the CU 6 assumes that the robot 11 is initially installed at the central coordinate which is the first trial installation position, that is, the origin of the robot coordinate is consistent with the central coordinate. On this assumption, the initial attitude of the base 13 of the robot 11 is decided (step S13). The initial attitude given to the base 13 in this stage is referred as an attitude (angle) of the base 13 which allows the center of the movable range of the shoulder 14 (the first axis) to be directed toward the workpiece W. The center of the movable range of the shoulder 14 is a central angle between a positive maximum movable angle and a native maximum movable angle of the shoulder 14, for instance, 0 degrees for a movable range of +90 degrees to −90 degrees, and +30 degrees for a movable range of +90 degrees to −30 degrees.

In this initial attitude of the base 13, the CPU 6 converts each arm tip-end position for imaging, which is expressed in the workpiece coordinate system by way of the coordinate system of the acquired image, to a position in the robot coordinate system. Based on this conversion, the CPU 6 estimates whether or not the center PO of the flange 18 of the robot 11 can reach each arm tip-end position for imaging and, under such a reached state, the base 13 takes an attitude to allow the light axis of the camera 12 to be directed toward each inspecting point C (step S14).

The CPU 6 further questions the results estimated at step S14 (step S15). If the answer at step S15 is YES, that is, there is a robot flange position that reaches the arm tip-end position and there is a robot base attitude that allows the camera light axis to be directed to the inspecting point, the CPU 6 assumes that it is possible to image the inspecting point C at all the arm tip-end positions for imaging. On this assumption, the CPU 6 stores the trial installation position (e.g., the initial trial position), the attitude of the base (e.g., the initial attitude), and the number of arm tip-end position for imaging into the RAM 8 (step S16).

It is then determined by the CPU 6 whether or not the estimation is completed at all angles of the base 13 (step S17). If this determination is NO, the CPU 6 changes the attitude of the base 13 (i.e., the directions of the X- and Y-axes) from the current attitude every predetermined angle within the range of +90 degrees to −90 degrees (step S18). After this, the processing is returned to step S14. For every attitude of the flange 18, the foregoing estimation to know whether or not it is possible to move to the arm tip-end position for imaging and it is possible to take the base attitude. Hence, at step S16, the CPU 6 can store into the RAM 8 information indicative of the trial installing positions, the attitude of the base 13, and the number of arm tip-end position for imaging.

When completing the estimation at all the base angles (attitudes) for each trial installation position (YES at step S17), it is then determined whether or not the estimation is completed for all the installation positions (step S19). If this determination shows NO, i.e., not yet completed, the processing is returned to step S12 for selecting the next trial installation position. Hence, the processing proceeds to the next trial installation position to repeatedly perform the foregoing estimation.

In the foregoing description, the determination at step S15 may be done after completing the estimation at step S14 for all the arm tip-end positions for imaging. On the other hand, in effect, the estimation at step S14 is repeated from the arm tip-end position which is the farthest from the robot in addition to considering the position at which the robot is to be installed and the attitude of the base. When it is determined NO at step S15, that is, it is determined that the flange 18 cannot move to the estimated arm tip-end position for imaging and the base cannot take the attitude for imaging, the estimation at step S14 is simplified from the next and subsequent estimation process (step S21). Practically, the estimation at arm tip-end positions which are near than the furthest position is stopped in the next and subsequent estimation process. The estimation at other trial installation positions farther than the current trial installation position from the workpiece is also stopped in the next and subsequent estimation process. Additionally, the estimation at step S14 at the attitude of the base which allows the arm tip end to be farther than that in the current base attitude is also stopped. That is, these cases are omitted from cases being calculated in the next and subsequent estimation process. After step S21, the processing proceeds to step S16.

In this way, the simplified estimation is commanded from the next and subsequent estimation process. This eliminates the useless estimation at arm tip-end positions that do not allow the flange 18 to be reached or the base cannot take its attitude necessary for imaging, thereby reducing calculation load to the CPU 6.

On completion of the estimation at step A14 with the attitude of the base changed at all the trial installation positions, the CPU 6 allows the display device 3 to display information of the installation-allowed positions for the robot 11 in a list format (step S20). The information of the displayed installation-allowed positions is composed of the trial installation positions and the attitudes of the base, which makes the flange 18 move to an arm tip-end position for imaging and makes the flange 18 take an attitude necessary for the imaging.

According to the present embodiment, as long as there are provided 3D profile data of a workpiece and there are decided portions for visual inspection, the position and attitude of a workpiece in the inspection station, the type of a robot being used, and a region in which the robot can be installed, it is easy to provide information showing what kind of lens should be mounted in the camera and at which position the robot 11 should be located, which information is sufficient for the actual visual inspection. Hence, in the present embodiment, the actual visual inspection apparatus is able to avoid its camera focus from blurring at a point being inspected of a workpiece and it is easier to perform the simulation for designing visual inspection systems.

In addition, design of visual inspection systems equipped with robots and cameras can be a kind of sales. When such sales are needed, it is frequent that, during the design of the systems, a robot being used is already decided but an installation position of the robot and a camera being used are not decided yet. In such a case, the simulator according to the present embodiment can be effectively used.

In the present embodiment, for a plurality of points being inspected of a workpiece, it is determined at first whether or not it is possible to move the tip end of the arm to a farthest position among the plurality of positions and deciding that it is possible to move the tip end of the arm to all of the plurality of positions when it is determined that it is possible to move the tip end of the arm to the farthest position. Based on this determination, the estimation in the next and subsequent estimation process is stopped or continued. Thus it is possible to avoid unnecessary calculation for the estimation.

### Second Embodiment

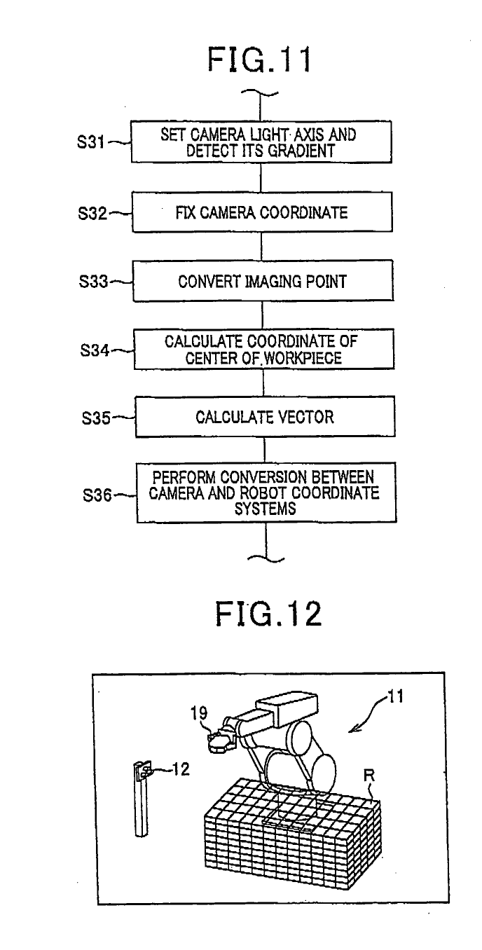

Referring to FIGS. 11-13, a second embodiment of the present invention will now be described. In the following, the components similar or identical to those of the foregoing first embodiment are given the same reference numerals for the sake of simplified explanation.

Compared to the first embodiment, the second embodiment differs, as shown in FIG. 12, in that the camera 12 is fixed at a home position and the workpiece W is held by a gripper 19 attached to the end of the arm of the robot 11. Additionally, in addition to the various programs stated in the first embodiment, the hard disk 9 stores data of a program for conversion between the coordinate system given to the camera and the coordinate system given to the robot with the use of the coordinate system provided by acquired images.

In the present embodiment, under the control of CPU 6, the display device 3 represents the 3D profile of a workpiece, information about inspecting points C and view points is calculated and an inspection range is specified. A lens is selected depending on the specified inspection range and an imaging point K is obtained in consideration of the focal distance of the selected lens. These steps are the same as steps S1 to S8 described in the first embodiment. After these steps, the following processing is carried out.

Using both the inspecting point C and the view point information, the CPU 6 sets a linear line as a light axis to the camera 12 and calculates the gradient of the light axis, in which the linear line connects a specified view point in the displayed image and the inspecting point C in the 3D coordinate system given to the workpiece (step S31 in FIG. 11).

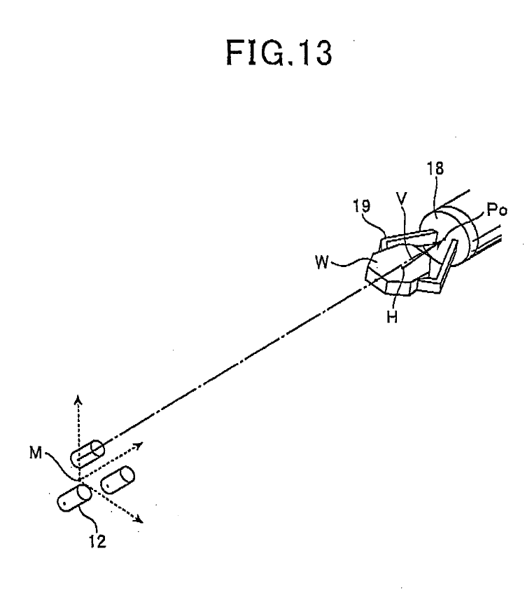

The operator assumes that the horizontal plane of the coordinate system of the acquired images represented by the display device 3 is the inspection station, and commands the CPU 6 to fix a camera coordinate M in the coordinate system of the images so that the camera takes a position and an attitude (direction) which should be provided in the inspection station (step S32). As shown in FIG. 13, the camera coordinate M correspond to a coordinate of the flange 18 in a coordinate system whose origin is located at the center PO of the flange 18, as described in the firs embodiment. The CPU 6 allows the display device 3 to represent the camera 12, in which the direction of the light axis of the camera 12 is set in the coordinate system of the image.

The CPU 6 uses the coordinate system of the image as a mediator in converting the imaging point K in the coordinate system of the workpiece into a position and an attitude (the gradient of the light axis) in the coordinate system of the camera (step S33). For each of the imaging points K, the CPU 6 obtains the coordinate of the center H of the workpiece W in the coordinate system of the camera using the gradient of the light axis and the profile data of the workpiece W (step S34).

Next, the CPU 6 responds to operator's commands from the mouse 5 to presumably set a state in which the gripper 19 is attached to the flange 18 of the robot 11. The CPU 6 assumes a workpiece W held by the gripper 19 in a desired attitude of the workpiece W and calculates a vector V extending from the center H of the workpiece W to the center PO of the flange 18 (step S35).

In summary, the mouse 5 is manipulated to represent the robot coordinate in the coordinate system of the image on the display screen, the coordinate conversion is made between the coordinate systems of both the camera and the robot using the coordinate system of the displayed image as a mediator. Based on both the central position of the workpiece W with regard to each of the imaging points K and the vector from the center of the workpiece W to the center PO of the flange 18, the center PO of the flange 18 and the attitude of the flange 18 are converted into positions in the robot coordinate system (step S36).

When the arm tip-end positions for imaging are obtained for each of the inspecting points, the steps which are the same step S10 and subsequent steps in the first embodiment are executed to provide the robot installation position candidates.

Hence, it is still possible for the simulator according to the second embodiment to provide the advantages stated in the first embodiment.

In the foregoing embodiments, when the installation-allowed position is composed of a plurality of installation-allowed positions, the simulator may comprise, as part of the determination means, means for calculating an average coordinate of the plurality of installation-allowed positions, means for setting an initial robot position which is an installation-allowed position which is the nearest to the average coordinate, means for determining whether or not it is possible to move the tip end of the arm to the position when it is assumed that the robot is installed at the initial robot position, and means for selecting the plurality of installation-allowed positions when it is determined that it is not possible to move the tip end of the arm to the obtained position, such that a position among the installation-allowed positions, of which distance to the obtained position is shorter than a distance to the average coordinate, is selected for the determination and a remaining position among the instillation-allowed positions, of which distance to the obtained position is longer than the position of the average coordinate, is removed from the determination. Hence, such a removal manner can reduce the calculation load.

In addition, in the foregoing embodiments, when the installation-allowed position is composed of a plurality of installation-allowed positions, the simulator may comprise, as part of the determination means, means for determining whether or not it is possible to move the tip end of the arm to the obtained position when it is assumed that the robot is installed at any of the installation-allowed positions, and means for selecting the plurality of installation-allowed positions when it is determined that it is not possible to move the tip end of the arm to the obtained position, such that a position among the installation-allowed positions, which is nearer than the installation-allowed position at which it is assumed that the robot is installed, is selected for the determination and a remaining position among the instillation-allowed positions, which is farther than the installation-allowed position at which it is assumed that the robot is installed, is removed from the determination. Hence, such a removal manner can also reduce the calculation load.

### Other Embodiments

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

For example, a workpiece may be mounted on an index table to turn the workpiece depending on an inspecting point. In this case, information showing the turned angle is used to perform the coordinate conversion on the assumption that the workpiece coordinate is turned at the same angle as that of the index table. In addition, the installation-allowed position may be one or plural in number. The robot is not limited to the foregoing vertical multi-joint type of robot. The lens (i.e., camera) is also not limited to one in number.

What is claimed is:

1. A simulator dedicated to a visual inspection apparatus equipped with a robot having an arm and a camera attached to a tip end of the arm, the camera inspecting a point being inspected of a workpiece, comprising:
display means that makes a display device three-dimensionally display the workpiece;
direction setting means that sets a direction of imaging the point being inspected of the workplace by displaying the workpiece on the display device from different view points, the direction of imaging being a light axis of the camera;
imaging point setting means that sets an imaging point to image the point being inspected of the workpiece using a lens of the camera, which lens is selected as being proper for imaging the point being inspected;
position/attitude obtaining means that obtains a position and an attitude of the tip end of the arm of the robot based on the direction of the imaging and the imaging- point;
representation means that represents the robot in a displayed image so that the robot is installed at an installation-allowed position which is set in the displayed image;
determination means that determines whether or not it is possible to move the tip end of the arm to the obtained position so that the camera is located at the imaging point and it is possible to provide the tip end of the arm with the obtained attitude so that, at a moved position of the tip end of the arm, the camera is allowed to image the point being inspected, when the robot is installed at the installation-allowed position which is set in the displayed image; and
output means that outputs the installation-allowed position for the robot as candidates of positions for actually installing the robot when it is determined by the determination means that it is possible to move the tip end of the arm and it is possible to provide the tip end of the arm with the obtained attitude.

2. The simulator of claim 1, wherein the point being inspected of the workpiece is composed of a plurality of points being inspected,
the position/attitude obtaining means includes means for obtaining a plurality of positions of the tip end of the arm for allowing the camera to image the plurality of points being inspected of the workpiece, and
the determination means includes means for determining, at first, whether or not it is possible to move the tip end of the arm to a farthest position among the plurality of positions and deciding that it is possible to move the tip end of the arm to all of the plurality of positions when it is determined that it is possible to move the tip end of the arm to the farthest position.

3. The simulator of claim 1, wherein the installation-allowed position is composed of a plurality of installation-allowed positions, and
the determination means includes
means for calculating an average coordinate of the plurality of installation-allowed positions,
means for setting an initial robot position which is an installation-allowed position which is the nearest to the average coordinate,
means for determining whether or not it is possible to move the tip end of the arm to the position when it is assumed that the robot is installed at the initial robot position,
means for selecting the plurality of installation-allowed positions when it is determined that it is not possible to move the tip end of the arm to the obtained position, such that a position among the installation-allowed positions, of which distance to the obtained position is shorter than a distance to the average coordinate, is selected for the determination and a remaining position among the instillation-allowed positions, of which distance to the obtained position is longer than the position of the average coordinate, is removed from the determination.

4. The simulator of claim 1, wherein the installation-allowed position is composed of a plurality of installation-allowed positions, and
the determination means includes
means for determining whether or not it is possible to move the tip end of the arm to the obtained position when it is assumed that the robot is installed at any of the installation-allowed positions, and
means for selecting the plurality of installation-allowed positions when it is determined that it is not possible to move the tip end of the arm to the obtained position, such that a position among the installation-allowed positions, which is nearer than the installation-allowed position at which it is assumed that the robot is installed, is selected for the determination and a remaining position among the instillation-allowed positions, which is farther than the installation-allowed position at which it is assumed that the robot is installed, is removed from the determination.

5. A simulator dedicated to a visual inspection apparatus equipped with a robot having an arm and a camera fixed located, the camera inspecting a point being inspected of a workpiece attached to a tip end of the arm, comprising:
display means that makes a display device three-dimensionally display the workpiece;
direction setting means that sets a direction of imaging the point being inspected of the workpiece by displaying the workpiece on the display device from different view points, the direction of imaging being a light axis of the camera;
direction matching means that matches the point being inspected of the workpiece with the light axis of the camera fixedly located;
imaging point setting means that sets an imaging point to image the point being inspected of the workpiece using a lens of the camera, which lens is selected as being proper for imaging the point being inspected;
position/attitude obtaining means that obtains a position and an attitude of the tip end of the arm of the robot based on the direction of the camera and the imaging point;
representation means that represents the robot in a displayed image so that the robot is installed at an installation-allowed position which is set in the displayed image;
determination means that determines whether or not it is possible to move the tip end of the arm to the obtained position and it is possible to provide the tip end of the arm with the obtained attitude so that, at a moved position of the tip end of the arm, the camera is allowed to image the point being inspected, when the robot is installed at the installation-allowed position which is set in the displayed image; and
output means that outputs the installation-allowed position of the robot as candidates of positions for actually installing the robot when it is determined by the determination means that it is possible to move the tip end of the arm and it is possible to provide the tip end of the arm with the obtained attitude.

6. The simulator of claim 5, wherein the point being inspected of the workpiece is composed of a plurality of points being inspected,
the position/attitude obtaining means includes means for obtaining a plurality of positions of the tip end of the arm for allowing the camera to image the plurality of points being inspected of the workpiece, and
the determination means includes means for determining, at first, whether or not it is possible to move the tip end of the arm to a farthest position among the plurality of positions and deciding that it is possible to move the tip end of the arm to all of the plurality of positions when it is determined that it is possible to m

7. The simulator of claim 5, wherein the installation-allowed position is composed of a plurality of installation-allowed positions, and
the determination means includes
means for calculating an average coordinate of the plurality of installation-allowed positions,
means for setting an initial robot position which is an installation-allowed position which is the nearest to the average coordinate,
means for determining whether or not it is possible to move the tip end of the arm to the position when it is assumed that the robot is installed at the initial robot position,
means for selecting the plurality of installation-allowed positions when it is determined that it is not possible to move the tip end of the arm to the obtained position, such that a position among the installation-allowed positions, of which distance to the obtained position is shorter than a distance to the average coordinate, is selected for the determination and a remaining position among the instillation-allowed positions, of which distance to the obtained position is longer than the position of the average coordinate, is removed from the determination.

8. The simulator of claim 5, wherein the installation-allowed position is composed of a plurality of installation-allowed positions, and
the determination means includes
means for determining whether or not it is possible to move the tip end of the arm to the obtained position when it is assumed that the robot is installed at any of the installation-allowed positions, and
means for selecting the plurality of installation-allowed positions when it is determined that it is not possible to move the tip end of the arm to the obtained position, such that a position among the installation-allowed positions, which is nearer than the installation-allowed position at which it is assumed that the robot is installed, is selected for the determination and a remaining position among the instillation-allowed positions, which is farther than the installation-allowed position at which it is assumed that the robot is installed, is removed from the determination.
